(19) United States
(12) Patent Application Publication
(10) Pub. No.: US 2026/0249941 A1
(43) Pub. Date: Aug. 27, 2026

(54) HOLDER WITH RETRACTABLE STORED STYLUS

(71) Applicant: Eagle Fan, Chu-Pei City (TW)

(72) Inventor: Eagle Fan, Chu-Pei City (TW)

(21) Appl. No.: 19/061,847

(22) Filed: Feb. 24, 2025

(51) Int. Cl. B62J 11/00

(52) U.S. Cl. CPC B62J 11/00

(57) ABSTRACT

A holder with retractable stored stylus is provided, including a fixing assembly, a carrying unit, a stylus, and an automatic cord-retracting device; the fixing assembly is used to be fixed on an installation piece, the carrying unit is rotatably installed on the fixing assembly and has a chamber communicating with the outside, and the stylus is partially inserted into the chamber and is disposed with a stylus tip and a joint end located away from the stylus; the automatic cord-retracting device is disposed inside the carrying unit and is disposed with a stretchable cord extendable into the chamber, and the cord is connected to the joint end. As such, the user can retrieve the stylus from the chamber for use, and after use, the joint end is pulled by the cord to enable the stylus to return to inside of the chamber.

### BACKGROUND OF THE INVENTION

### 1. Field of the Invention

The present invention relates generally to a holder with retractable stored stylus to be mounted on motorcycles.

### 2. the Prior Arts

Some people enjoy riding motorcycles for fun. Most riders, especially heavy-duty motorcycle riders, will install mobile phone holders on their motorcycles to use their mobile phones in a hands-free manner. In addition to providing navigation functions to unfamiliar destinations, they can also use the mobile phones to record the journey and plays music at the right time, providing a more comfortable experience while riding.

To protect the rider's own safety while riding, most riders wear a protective jumpsuit, leather boots, gloves, and a helmet to increase the safety in riding. However, gloves greatly hinder the control of the mobile phone through the touch screen. Therefore, some riders will stop temporarily to take off their gloves when they need to use the touch screen to control the mobile phone, causing immense inconvenience.

Therefore, some riders will carry a stylus and use the stylus to control the mobile phone. In order to prevent the stylus from falling, a spiral telescopic cord is often attached to the stylus and the other end of the telescopic cord is fixed on the motorcycle or the user. As such, when the motorcycle is traveling at high speed or under strong winds, it is easy to pull the spiral telescopic cord to randomly flap, which is not only distractive, but also dangerous if the spiral telescopic cord flaps too much or even flap off.

### SUMMARY OF THE INVENTION

A primary objective of the present invention is to provide a holder with retractable stored stylus, to be directly mounted on a motorcycle. When stored, the stylus can be easily taken out for use and the stylus can be automatically pulled by a cord and return to the original position after use, which makes the riding not only safer, but also more convenient for the rider to use a stylus to control the mobile phone through the touch screen.

In order to achieve the aforementioned objective, the present invention provides the following technical solutions:

The present invention provides a holder with retractable stored stylus, which includes: a fixing assembly, a carrying unit, a stylus, and an automatic cord-retracting device; the fixing assembly is used to be fixed on an installation piece, the carrying unit is rotatably installed on the fixing assembly and has a chamber communicating with the outside, and the stylus is partially inserted into the chamber and is disposed with a stylus tip and a joint end located away from the stylus; the automatic cord-retracting device is disposed inside the carrying unit and is disposed with a stretchable cord extendable into the chamber, and the cord is connected to the joint end. As such, the user can retrieve the stylus from the chamber for use, and after use, the joint end is pulled by the cord to enable the stylus to return to inside of the chamber.

In a preferred embodiment, the fixing assembly comprises a first arc-shaped member and a second arc-shaped member, and the first arc-shaped member and the second arc-shaped member are clamped in an overlapping manner on an outer wall of the installation piece.

In a preferred embodiment, the first arc-shaped member and the second arc-shaped member are connected as follows: the ends of the first arc-shaped member and the second arc-shaped member to be docked are pivotally connected, and the other ends of the first arc-shaped member and the second arc-shaped member are locked with screws and nuts.

In a preferred embodiment, the fixing assembly further comprises a C-shaped anti-skid piece, the C-shaped anti-skid piece is stretchable to be placed on the outer wall of the object to be mounted on, and the first arc-shaped member and the second arc-shaped member are coupled and clamped to the outer wall of the C-shaped anti-skid piece.

In a preferred embodiment, the carrying unit comprises a first shell, a second shell, and a chamber shell; the automatic cord-retracting device and the chamber shell are located inside a space formed by the coupling of the first shell and the second shell, the chamber shell has a chamber that communicates with the outside, the chamber shell has a hole away from the chamber opening, and the cord of the automatic cord-retracting extends through the hole into the chamber.

In a preferred embodiment, the inner wall of the first shell has at least a first convex strip, the inner wall of the second shell has at least a second convex strip, and the outer wall of the chamber shell has at least a concave groove, when the first shell and the second shell are coupled, the first convex strip and the second convex strip are located in the corresponding groove.

In a preferred embodiment, the chamber is in the shape of a trumpet that tapers from outside to inside.

In a preferred embodiment, the outer wall of the carrying unit has a shaft, the outer wall of the fixing assembly has an shaft seat, the shaft is located in the shaft seat and locked in a rotatable manner, and the carrying unit is rotatably installed on the fixing assembly.

In a preferred embodiment, the stylus has a soft tube wall, and the tube wall has at least one peak edge that is convex in the form of a mountain peak.

Compared with the prior art, the holder with retractable stored stylus of the present invention is usually installed on the installation piece of the motorcycle by the fixing assembly when not in use, leaving only the stylus partially exposed, and there is no excess cord exposed, therefore, not affecting the concentration and safety when riding the motorcycle. To use the stylus, the rider can easily retrieve the stylus from the chamber and use on the mobile phone screen. If there are water droplets on the screen, the peak edge of the tube wall of the stylus can be used to scrape the droplets off to avoid poor induction during operation. When not in use, the joint end is pulled by the cord to allow the stylus to return to the chamber, which provides excellent convenience.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of the present invention.

FIG. 2 is a perspective view of the present invention from another angle.

FIG. 3 is an exploded view of the present invention.

FIG. 4 is a front view of the stylus of this invention.

FIG. 5 is a schematic view of the present invention in use.

### DETAILED DESCRIPTION OF THE PREFERRED EMBODIMENT

The technical solutions of the present invention will be described clearly and completely below in conjunction with the specific embodiments and the accompanying drawings. It should be noted that when an element is referred to as being “mounted or fixed to” another element, it means that the element can be directly on the other element or an intervening element may also be present. When an element is referred to as being “connected” to another element, it means that the element can be directly connected to the other element or intervening elements may also be present. In the illustrated embodiment, the directions indicated up, down, left, right, front and back, etc. are relative, and are used to explain that the structures and movements of the various components in this case are relative. These representations are appropriate when the components are in the positions shown in the figures. However, if the description of the positions of elements changes, it is believed that these representations will change accordingly.

Unless otherwise defined, all technical and scientific terms used herein have the same meaning as commonly understood by one of ordinary skill in the art of the present invention. The terminology used herein is for the purpose of describing particular embodiments only and is not intended to limit the present invention. As used herein, the term “and/or” includes any and all combinations of one or more of the associated listed items.

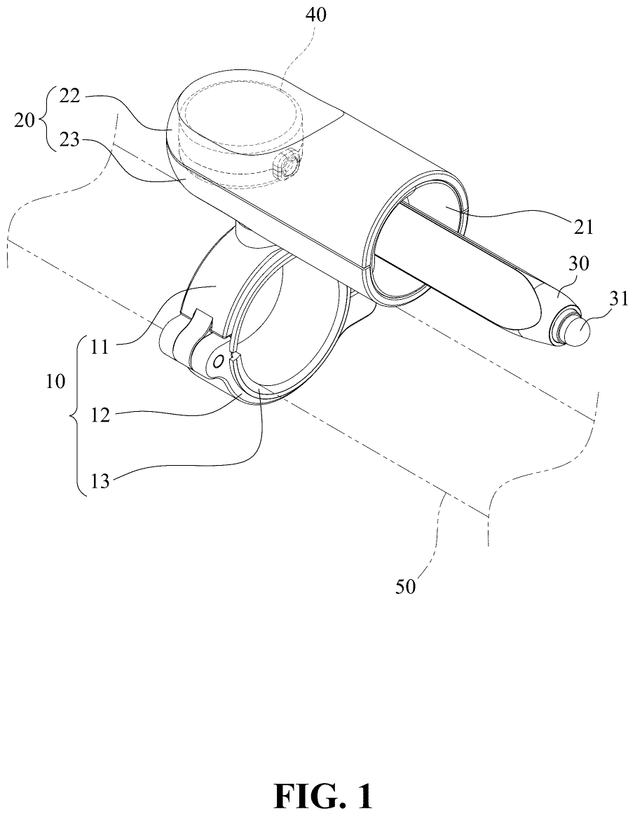

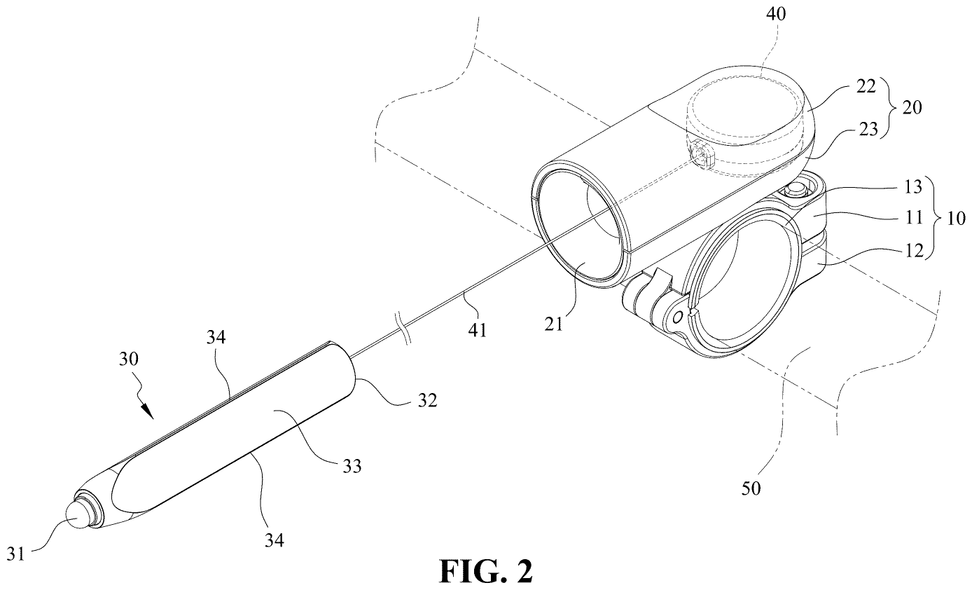

As shown in FIGS. 1 and 2, the present invention is a holder with retractable stored stylus, which includes: a fixing assembly 10, a carrying unit 20, a stylus 30, and an automatic cable retractor 40. The fixing assembly 10 is used to be mounted on an installation a mounting piece 50, which can be a support rod at the motorcycle handle bar. The carrying unit 20 is rotatably mounted on the fixing assembly 10; the carrying unit 20 has a chamber 21 that communicates with the outside; the stylus 30 is partially inserted into the chamber 21, and the stylus 30 has a stylus tip 31 and a joint end 32 away from the stylus tip 31; the automatic cord-retracting 40 is provided inside the carrying unit 20, and the automatic cord-retracting 40 is provided with a stretchable cord 41 that extends into the chamber 21, the cord 41 is connected to the joint end 32, whereby the user retrieve the stylus 30 from the chamber 21 for use. When not in use, the cord 41 pulls the joint end 32 so that the stylus 30 returns to the chamber 21.

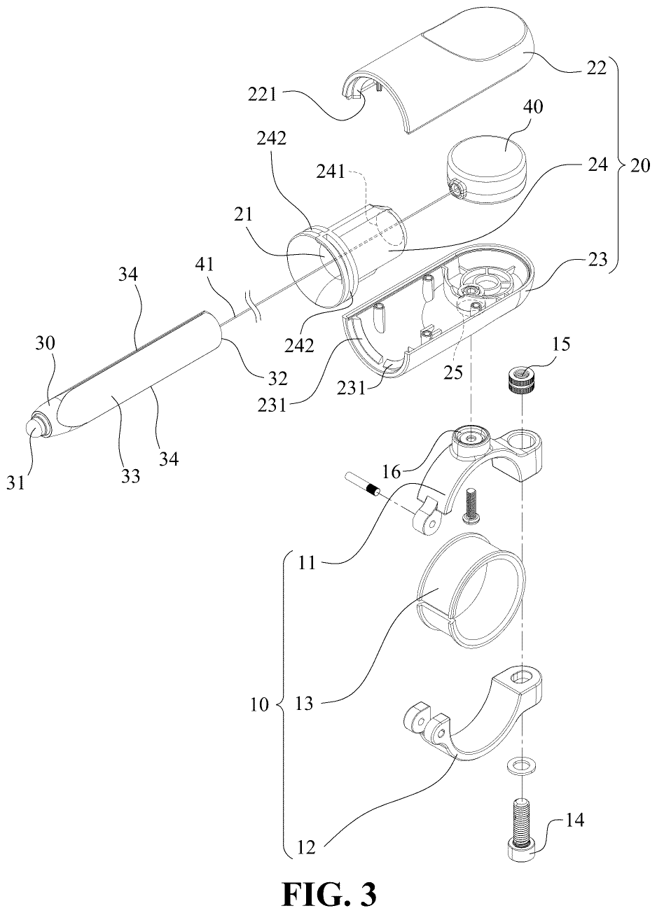

The following describes the structure of the present invention. Referring to FIG. 3:

The fixing assembly 10 is used to fix the installation piece 50. In the present embodiment, the installation piece 50 is a support rod near the handle of the heavy-duty motorcycle. Since most of the current support rods are cylindrical, the fixing assembly 10 of the present invention is accordingly designed to be fixed on a cylindrical installation piece 50. The fixing assembly 10 includes a first arc-shaped member 11 and a second arc-shaped member 12. The main bodies of the first arc-shaped member 11 and the second arc-shaped member are in the shape of a semi-circular arc. After coupled, the two arc-shaped members can be fixed on the circular outer wall of the installation piece 50. The connection structure of the first arc-shaped member 11 and the second arc-shaped member 12 is pivotally connected at one end of the coupling, and the other end is locked with a screw 14 and a nut 15 to achieve the required firmness.

In addition, in order to increase the firmness and scope of application, the fixing assembly 10 also includes a C-shaped anti-skid piece 13. During installation, the C-shaped anti-skid piece 13 can be temporarily stretch to open and then placed on the outer wall of the installation piece 50. Then, the first arc-shaped member 11 and the second arc-shaped member 12 are coupled and clamped to the outer wall of the C-shaped anti-skid piece 13 to achieve excellent firmness during subsequent locking. In addition, when the present invention is applied to different types of heavy-duty motorcycles, the diameters of the mounting parts 50 may also be different. In this case, by replacing the C-shaped anti-skid pieces 13 with different inner diameters, the first arc-shaped member 11 and the third arc-shaped member 12 can be clamped and locked without having to replace the first arc-shaped member 11 and the second arc-shaped member 12, thereby expanding the applicable scope of the present invention at a lower cost.

The carrying unit 20 is used to store the stylus 30 and is rotatably installed on the fixing assembly 10. The rotatable design is intended to allow the user to have more angles to retrieve the stylus 30. The carrying unit 20 includes a first shell 22, a second shell 23, and a chamber shell 24. The automatic cord-retracting 40 and the chamber shell 24 are located in a space formed by the coupling of the first shell 22 and the second shell 23, and the chamber shell 24 has a chamber 21 that communicates with the outside. The chamber 21 is in the shape of a trumpet that tapers from the outside to the inside, so that the cord 41 can smoothly pull the stylus 30 back into the chamber 21. The chamber shell 24 has another hole 241 away from the opening of the chamber 21. The cord 41 of the automatic cord-retracting device 40 extends into the chamber 21 through the hole 241.

In the present embodiment, the inner wall of the first shell 22 also has at least one first convex strip 221, and the inner wall of the second shell 23 has at least one second convex strip 231. At the corresponding position, the outer wall of the chamber shell 24 has at least one concave groove 242. When the first shell 22 and the second shell 23 are coupled, the first convex strip 221 and the second convex strip 231 are located in the corresponding concave groove 242, and then a glue is applied to fix the coupling; therefore, the position of each component will not move randomly.

In addition, the carrying unit 20 is rotatably installed on the fixing assembly 10. This rotatable structure is provided with a shaft 25 on the outer wall of the carrying unit 20, and the outer wall of the fixing assembly 10 is provided with a shaft seat 16. In the present embodiment, the shaft 25 is protrudingly provided at the outer wall of the second shell 23 facing the fixing assembly 10, and the shaft seat 16 is provided at the outer wall of the first arc-shaped member 11 facing the carrying unit 20. For assembly, the shaft 25 will be locked after located on the shaft seat 16, without hindering the rotation of the two. In addition, the shaft 25 should be locked with appropriate tightness, so that the carrying unit 20 can be positioned at this angle after being rotated and adjusted on the fixing assembly 10, as shown in FIGS. 1 and 2 respectively.

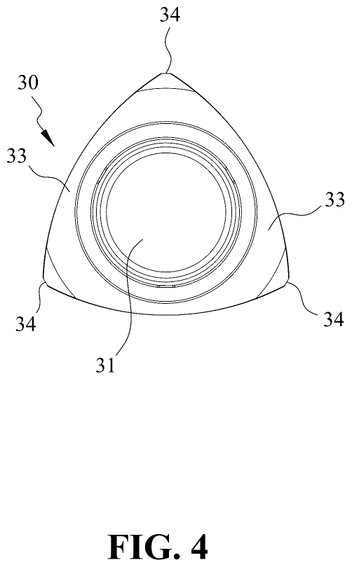

The stylus 30 is provided with a stylus tip 31 and a joint end 32 away from the stylus tip 31. The stylus 30 uses the stylus tip 31 to contact the touch screen of the mobile phone to operate, and the joint end 32 is used for the cord 41 to be coupled thereto. Referring to FIG. 4, the stylus 30 has a soft tube wall 33. For example, the tube wall 33 can be made of rubber. The tube wall 33 has at least one peak edge 34 protruding in the form of a mountain peak. In the present embodiment, three peak edges 34 are formed at equal angles. When it rains or water droplets appear on the touch screen, the peak edges 34 can be used to scrape off the water droplets on the screen surface to prevent the stylus tip 31 from being damaged and losing the sensing effect when in contact with the touch screen.

The automatic cord-retracting device 40 is an existing product and is provided with a stretchable cord 41. The cord 41 is preferably a metal wire. The automatic cord-retracting device 40 is provided with an elastic reset part and a catch part. The catch part can temporarily catch the cord 41 after the cord 41 is pulled out to stop the cord 41 from being retracted, which is convenient for the operation of the stylus 30 when the cord 41 is retracted. The cord 41 must be pulled first to trigger the retracting mechanism, and then the elastic reset part can be used to quickly retract the cord 41 after the external force disappears.

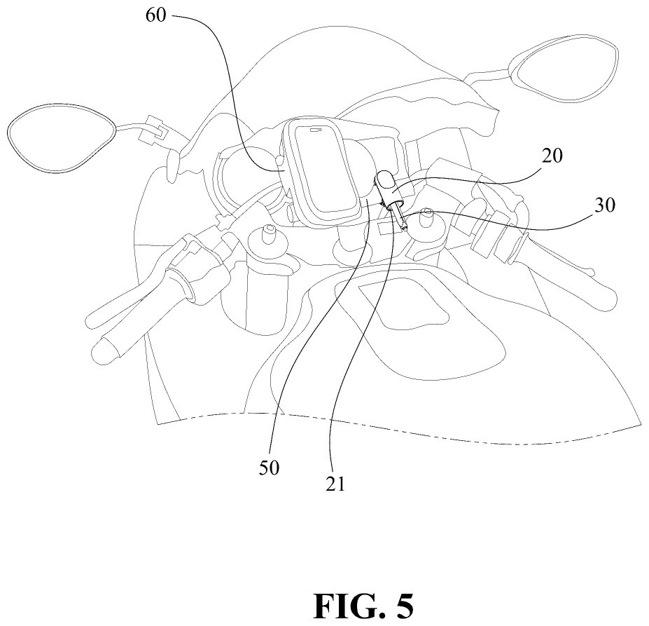

FIG. 5 shows a schematic view of the actual use of the present invention. A mobile phone holder 60 is fixed on the installation piece 50 of the heavy-duty motorcycle. The holder of the present invention is also mounted on the round rod-shaped installation piece 50 using the fixing assembly 10. After installation, if the rider is unable to operate the touch screen of the mobile phone because of wearing gloves, the rider can easily retrieve the stylus 30 from the chamber 21 of the carrying unit 20, and use the stylus 30 to contact the touch screen of the mobile phone for operation. When finishing using the stylus, pulling the cord 41 slightly to trigger the cord retracting mechanism of the automatic cord-retracting device 40, so that the cord 41 pulls the joint end 32 to return the stylus 30 into the chamber 21. As such, it will not only be more convenient for those riding heavy motorcycles to use mobile phones, but also there will be no exposed wires, making it safer while riding the motorcycle.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A holder with retractable stored stylus, comprising:
a fixing assembly, used to be fixed on an installation piece;
a carrying unit, rotatably installed on the fixing assembly and having a chamber communicating with the outside;
a stylus, partially inserted into the chamber and disposed with a stylus tip and a joint end located away from the stylus; and
an automatic cord-retracting device, disposed inside the carrying unit and disposed with a stretchable cord extendable into the chamber, and the cord being connected to the joint end for a user to retrieve the stylus from the chamber for use, and after use, the joint end being pulled by the cord to enable the stylus to return to inside of the chamber.

2. The holder with retractable stored stylus according to claim 1, wherein the fixing assembly comprises a first arc-shaped member and a second arc-shaped member, and the first arc-shaped member and the second arc-shaped member are clamped in an overlapping manner on an outer wall of the installation piece.

3. The holder with retractable stored stylus according to claim 2, wherein he first arc-shaped member and the second arc-shaped member are connected as follows: the ends of the first arc-shaped member and the second arc-shaped member to be docked are pivotally connected, and the other ends of the first arc-shaped member and the second arc-shaped member are locked with screws and nuts.

4. The holder with retractable stored stylus according to claim 2, wherein the fixing assembly further comprises a C-shaped anti-skid piece, the C-shaped anti-skid piece is stretchable to be placed on the outer wall of the object to be mounted on, and the first arc-shaped member and the second arc-shaped member are coupled and clamped to the outer wall of the C-shaped anti-skid piece.

5. The holder with retractable stored stylus according to claim 1, wherein the carrying unit comprises a first shell, a second shell, and a chamber shell; the automatic cord-retracting device and the chamber shell are located inside a space formed by the coupling of the first shell and the second shell, the chamber shell has a chamber that communicates with the outside, the chamber shell has a hole away from the chamber opening, and the cord of the automatic cord-retracting extends through the hole into the chamber.

6. The holder with retractable stored stylus according to claim 5, wherein the inner wall of the first shell has at least a first convex strip, the inner wall of the second shell has at least a second convex strip, and the outer wall of the chamber shell has at least a concave groove, when the first shell and the second shell are coupled, the first convex strip and the second convex strip are located in the corresponding groove.

7. The holder with retractable stored stylus according to claim 1, wherein the chamber is in the shape of a trumpet that tapers from outside to inside.

8. The holder with retractable stored stylus according to claim 1, wherein the outer wall of the carrying unit has a shaft, the outer wall of the fixing assembly has an shaft seat, the shaft is located in the shaft seat and locked in a rotatable manner, and the carrying unit is rotatably installed on the fixing assembly.

9. The holder with retractable stored stylus according to claim 1, wherein the stylus has a soft tube wall, and the tube wall has at least one peak edge that is convex in the form of a mountain peak.
